(19) United States
(12) Patent Application Publication
(10) Pub. No.: US 2009/0104038 A1
(43) Pub. Date: Apr. 23, 2009

(54) Airfoil Family for a Blade of a Wind Turbine

(76) Inventor: Peter Grabau, Kolding (DK)

Correspondence Address: DAY PITNEY LLP, 7 TIMES SQUARE, NEW YORK, NY, 10036-7311, US

(21) Appl. No.: 12/086,649

(22) PCT Filed: Dec. 20, 2006
(86) PCT No.: PCT/DK2006/000731

§ 371 Date: Oct. 27, 2008

(30) Foreign Application Priority Data
Dec. 20, 2005 (PA) PA 2005 01800

(51) Int. Cl. F03D 1/06

(52) U.S. Cl. 416/219 R; 416/223 R

(57) ABSTRACT

A wind turbine rotor blade comprising a series of profiles is presented, which series of profiles comprises a number of profiles describing the outline of the blade transversally of its longitudinal axis, wherein some of the profiles of the series of profiles comprise approximately the same profile rear edge which describes at least a portion of the rear edge of the blade. The rear edge of the blade is configured in one piece and/or of a flexible material. Moreover a method of designing a series of profiles for a wind turbine rotor blade is presented.

The invention relates to a series of profiles for at least a portion of a blade comprising several profiles describing the outline of the blade transversally to its longitudinal axis. The invention also relates to a method of designing a series of profiles and a blade featuring such series of profiles.

### BACKGROUND

Blades/wings for aircrafts, helicopters, wind turbines, etc., are made from series of profiles that describe the cross section of the blade/wing in various positions along the length of the blade/wing. The profiles are determined on the basis of parameters such as eg optimal lift coefficients at specific height/width-ratios, or, for a blade for wind turbines, more generally to provide maximal power yield at specific rates of rotation. Wings for aircrafts are often defined on the basis of the same profile in all cross-sections, but scaled in size. This is not the case for blades for wind turbines that are often built over a series of profiles with a number of different profiles throughout the length of the blade, between which interpolation or blending is made to the effect that a smooth transition between the profiles is provided.

Both in the context of design, manufacture and use of the blade, specific problems or considerations are associated with the rear edge of the blade. Thus, it is known to design blades with a rear edge which is made to purpose, eg completely sharp, serrated, with extra small profiles mounted on the blade or with a specific surface primarily with the aim of reducing noise from the blade.

Moreover, the rear edge on the blade is exposed to large fatigue loads in operation which lead to much wear with an ensuing need for repairs. This in inconvenient, in particular in case of blades for wind turbines, such repair entailing both that the production of power is to be discontinued for a protracted period of time and that there is a need for lifting equipment, such as crane or helicopter to remedy the damage, unless it is necessary to actually replace the blade.

Wings/blades for aircrafts and wind turbines often consist of blade shells that are joined by gluing, most often with joints at the fore edge and at the rear edge. During the manufacture the shells are glued to each other, the wing/blade is sanded to the requisite extent along the joint which is cleaned and painted. Alternatively the blade shells can be kept together like in EP 1 184 566 by a metal profile with is clamped securely around the rear edges of the blade shells throughout the major part of the expanse of the wing/blade. The final configuration of the rear edge is consequently associated with comparatively large inaccuracies and large tolerances and, likewise, the production is both work-intensive, time-consuming and, as far as glued blade parts are concerned, problems arise in connection with the working environment due to the dust from the sanding.

Moreover, the rear edges of the wings/blades constitute a comparatively fragile part which is easily and frequently damaged during eg transport and mounting.

### OBJECT AND DESCRIPTION OF THE INVENTION

It is the object of the invention to provide a series of profiles for a blade with good aerodynamic properties and presenting further advantages concerning the configuration of the rear edge of the blade.

Thus, the present invention relates to a series of profiles for at least a portion of a blade comprising several profiles that describe the outline of the blade transversally of its longitudinal axis, wherein at least some of the profiles in the series of profiles comprise approximately the same profile rear edge describing at least a portion of the rear edge of the blade. This enables manufacture, in a simple manner, of a rear edge in one piece for the entire or long lengths of the blade, which is advantageous, since it is hereby possible to manufacture the rear edge expediently and inexpensively, eg by pultrusion or extrusion. By manufacturing the rear edge of the blade separately, its configuration and dimensions can be controlled accurately, which may be extremely difficult and cost-intensive with current methods of manufacture. The blade rear edge produced can thus either be mounted on the remainder of the blade or optionally be moulded integrally there with, and timewise heavy and cost-intensive production phases in the conventional production, such as sanding and painting, can be obviated. Likewise, the invention enables that the rear edge of the blade can be made of another material than the blade as such. For instance a lighter material, whereby the overall weight of the blade can be reduced considerably, or a flexible material such as rubber. The latter is advantageous, on the one hand by reducing the noise emitted by the blade in use and, on the other, by making the rear edge less receptive towards scratches and damage in connection with transport and handling in general. Should the rear edge be damaged or worn, it is also simple to replace. By configuring the rear edge as a separate part applied onto the remainder of the blade structure, the strains and tensions in the rear edge can also be reduced considerably, whereby the blade structure is generally considerably enhanced. Moreover, a rear edge as described above can also advantageously be combined with blades in accordance with the owl's wing principle. Here the noise emission of the blade is reduced considerably in that fibres of flexible material are applied onto the blade, protruding beyond the rear edge. It is a major drawback of such blades that such fibres or flexible material are quickly worn and therefore necessitate maintenance or replacement. However, this is not a major problem when a blade with a rear edge according to the present invention is concerned, since, here, it is a simple and quick procedure to replace the entire rear edge of the blade, if necessary.

According to one embodiment of the invention, the series of profiles for a blade according to the above is further described in that at least some of the profiles of the series of profiles are determined on the basis of the profile rear edge. Hereby the advantageous aspect is accomplished that all the profiles are designed to be optimal relative to the selected rear edge, whereby a blade configured in accordance with the series of profiles can be manufactured with a rear edge produced in one or more pieces with the advantages mentioned above.

A further embodiment relates to a series of profiles for a blade, wherein the profile rear edge is repeated, rotated or displaced from one profile to another. Hereby the rear edge of the blade can still be manufactured in a small number of pieces or one single piece that are/is applied onto the remainder of the blade, optionally slightly twisted.

Yet an embodiment relates to a series of profiles for a blade, wherein at least some of the profiles of the series of profiles are determined on the basis of a number of different, alternative profile rear edges. Hereby the series of profiles is designed to be optimal in case of a number of different rear edges (optionally optimal in the light of different criteria for the different profile rear edges). Hereby the same primary-blade structure can be combined with different rear edges and hence be designed optimally for different aerodynamic properties. The same blade mould can thus be used to manufacture different types of blades. Likewise a blade can be adapted to the specific needs or desires of a customer, quite simply by selection of a suitable rear edge. For instance, a blunt rear edge can be replaced by a sharp rear edge; the blade can be made wider by selecting a correspondingly wider rear edge, whereby the optimal number of revolutions for the blades is reduced, reducing the noise accordingly.

Finally, the invention relates to a series of profiles for a blade according to the above, wherein the width of the profile rear edge constitutes approximately 2-10% of the width of the profile.

The present invention also relates to a blade as described at least partially by a series of profiles as taught above. The advantages thereof are as described in the context of a series of profiles according to the invention.

According to one embodiment of the invention, at least a portion of the rear edge of the blade is made in one piece and/or manufactured from another material than the remainder of the blade surface. According to yet an embodiment, the material may be a flexible material, such as eg rubber. As mentioned above, hereby a quieter blade is accomplished as well as a rear edge which is not so easily damaged during transport.

According to a further embodiment of the invention, the rear edge of the blade is exchangeable or constitutes a movable flap. By allowing the rear edge to consist of few pieces or one piece, it is a comparatively simple and inexpensive procedure to configure the blade with active flaps.

Moreover, according to yet an embodiment, the rear edge of the blade may comprise a lightning conducting device. A lightning conducting device such as a copper cable can be arranged and mounted, in a simple manner, in the rear edge of the blade according to the invention. Likewise, the cable can be isolated from the remainder of the blade by the rear edge being as such made of an insulating material.

The invention further relates to a wind turbine comprising at least one blade described by the above teachings and a series of profiles for the manufacture of a blade, said series of profiles being as described above. The advantages of this are as mentioned above.

Finally the invention relates to a method of designing a series of profiles for at least a portion of a blade comprising several profiles describing the outline of the blade transversally of its longitudinal axis, said method comprising to determine the shape of a profile rear edge describing at least a portion of the rear edge of the blade. The profile rear edge is repeated at least in a part of the profiles in the series of profiles, and the remainder of the profiles in the series are determined on the basis there on.

### BRIEF DESCRIPTION OF DRAWINGS

In the following, the invention is described with reference to the figures, wherein

FIG. 1 shows a blade for a wind turbine according to the prior art described by a number of profiles;

FIG. 2 shows a blade with a rear edge according to the invention;

FIG. 3 shows a series of profiles according to the present invention with a fixed rear edge;

FIG. 4 shows another series of profiles according to the present invention with a fixed, but rotated rear edge;

FIG. 5 shows a blade profile designed for several alternative rear edges;

FIG. 6 shows a blade profile according to the invention with a movable rear edge acting as a flap; and

FIG. 7 shows a blade profile according to the invention, where the rear edge does not constitute a load-bearing part of the profile.

### DESCRIPTION OF EMBODIMENTS

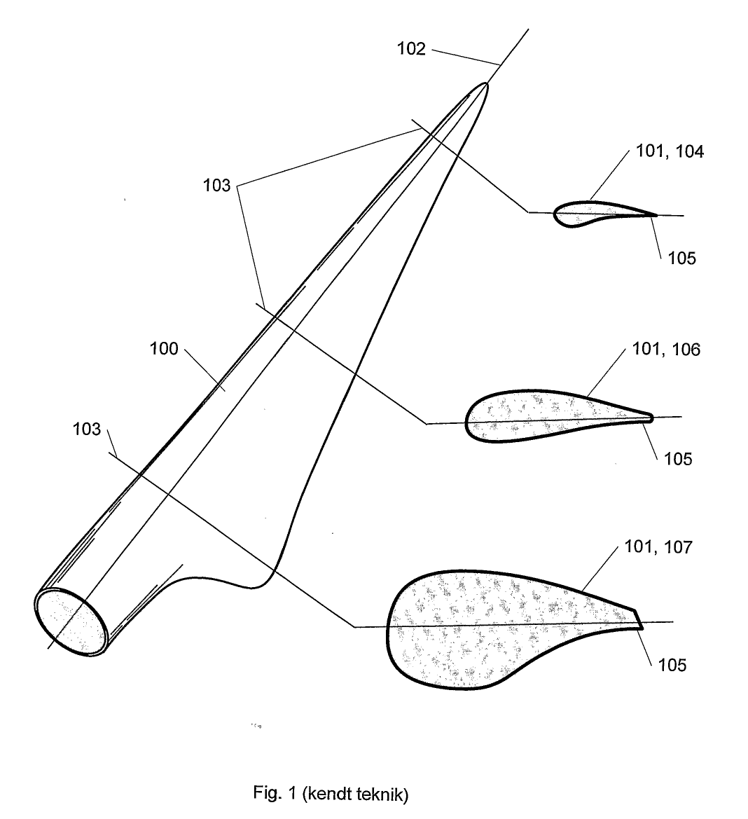

FIG. 1 shows a blade 100 for a wind turbine according to the prior art. The blade is described by a number of profiles 101 as outlined next to the blade. Each profile 101 indicates the outer contour of the blade 100 in a cross-sectional view in a given position down along the longitudinal axis 102 of the blade corresponding to a cross-section along the marked lines 103. Series of profiles for wings of aircrafts often consist of the same type of profile which is then scaled to size outwards of the wing. This is often not the case with blades for wind turbines which may instead be given by series of profiles featuring different types of profiles, between which the surface of the blade is thus interpolated or blended, and a smooth transition is created between the various profiles. This is illustrated by the blade shown in FIG. 1 which, in a position most distally at the blade tip, is defined by a profile 104 featuring a sharp rear edge 105. A sharp rear edge is advantageous in that it considerably reduces the noise from the blade. Further up on blade 100, another profile is imparted to the outline of the blade, one with a rounded or blunt rear edge, which is often simpler and quicker to manufacture than an entirely sharp or pointed rear edge, and which is not as fragile or receptive to impacts or blows either. The series of profiles in the example shown in FIG. 1 further consists of a third profile 107 that describes the blade 100 approximately at its widest section. Here, the rear edge 105 is cut off at an angle. The profiles 101 in a series of profiles may, as will appear from the example shown in FIG. 1, be even very different, not only as far as the configuration of the rear edge is concerned, but also inasmuch as their foremost part and their height/width-ratio are concerned.

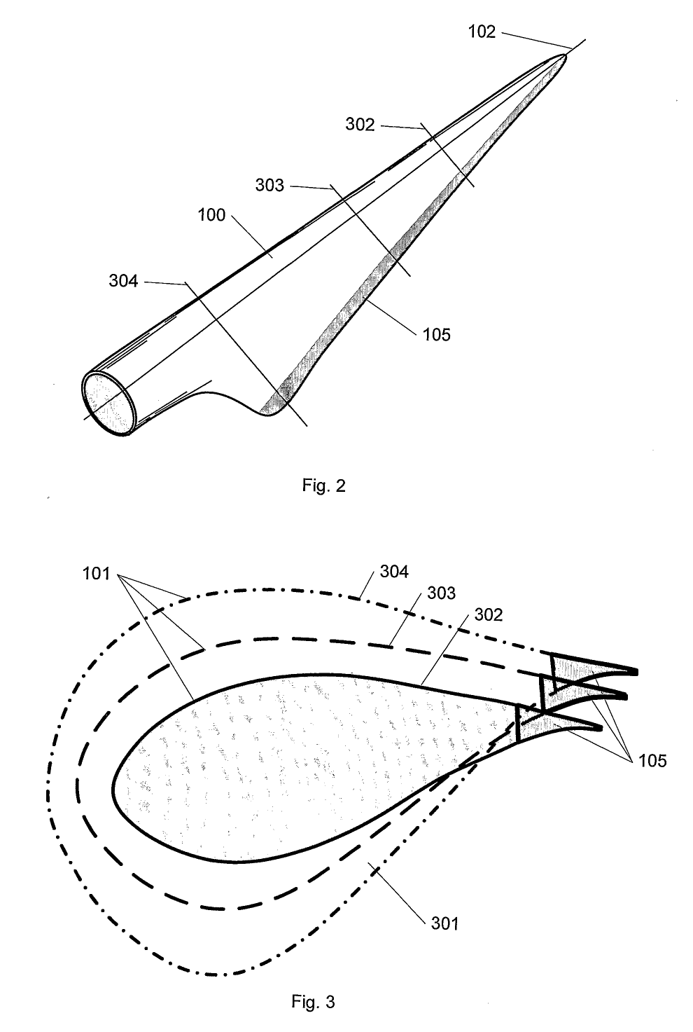

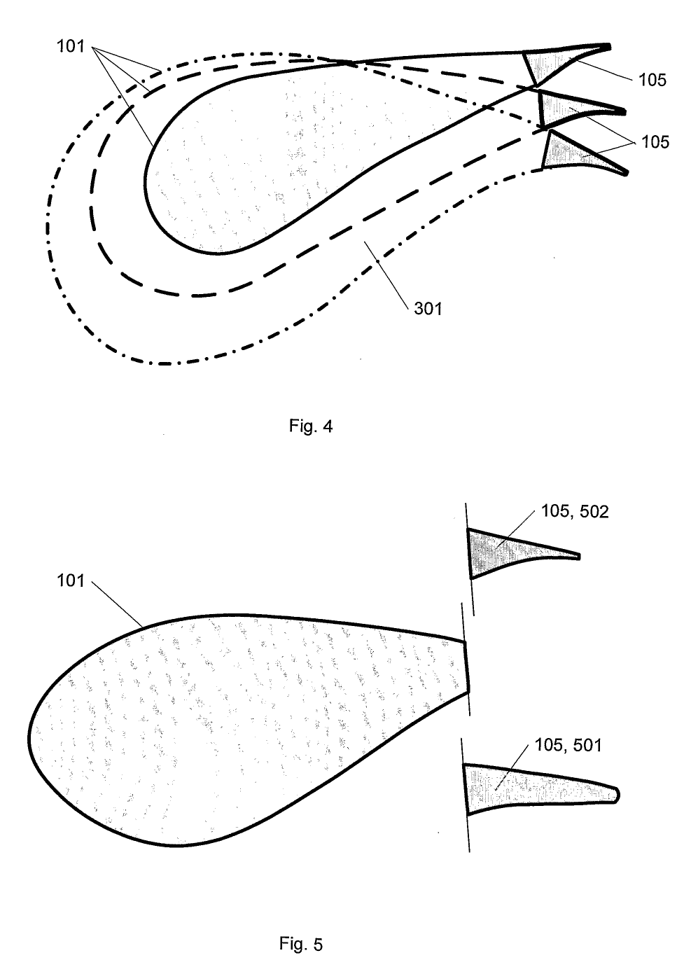

FIG. 2 shows a blade for a wind turbine 100 according to the invention which is defined on the basis of a series of profiles, in which the profile rear edge 105 or the rearmost part of each profile is fixed and is identical throughout all profiles in the series 101. Such series of profiles 301 is shown in FIG. 3, consisting of three profiles 101 from three different positions along the length of the blade; at the widest point on the blade 304; slightly less than halfways along the blade (about 25% from the root) 303; and about 35% down the blade 302. The profiles of FIG. 3 are shown as arranged, seen inwards from the root of the blade and outwards along the longitudinal axis 102 of the blade. As will appear from the Figure, all three profiles in the series of profiles have the same and identical profile rear edges 105 indicated by dark grey. According to another embodiment of the invention not all, but merely a number of the profiles in a series are configured with an identical profile rear edge corresponding to a fixed rear edge in a given part of the length of the finished blade. In the shown embodiment, the profile rear edge 105 was repeated somewhat displaced in the individual profiles 101, but they could also have been arranged identically on top of each other or be repeated rotated, which embodiment is shown in FIG. 4. In the shown examples, the profile rear edge constitutes about 2-10% of the width of the profiles, corresponding to about 5-10 cm on a blade of a width of about 6 m, but—in other embodiments—it may assume other dimensions and thus only concern the most distal area around the rear edge or a larger area.

A number of advantages arise when allowing the profile rear edges to be identical for the entire or a part of a series of profiles. Thus, this enables the blade 100 described by the series of profiles 301 to have a rear edge 105 which is configured in one piece throughout the entire or major parts of the length of the blade as shown in FIG. 2. This makes it possible to manufacture a rear edge with a higher degree of accuracy than is possible when, as is the ordinary, the rear edge is a part of the blade shells. Conventionally a blade is made of two or more blade shells that are glued to each other with a joint at the fore edge and the rear edge of the blade. As also described in the introductory part, there may thus be large variations in the thickness of the rear edge and its finish which is remedied by sanding and renewed painting. Such production phases with sanding and painting can be avoided by configuring the rear edge of the blade in one or more separate parts. Such rear edge can be made in a simple manner and at low production costs, eg by pultrusion or extrusion, precisely because of it having the same cross-section throughout the entire length as described by a series of profiles according to the invention. In that case the rear edge can either be mounted on the remainder of the blade in a subsequent step or be moulded integrally with one of the blade shells.

Likewise, the rear edge of the blade can be manufactured in a simple manner in another material which is different from that of the remaining parts of the blade shells. For instance, a rear edge of glass fibre can be mounted on a blade dominated by carbon fibre material, whereby weight is saved on the blade in an area where the strength properties of the blade are not paramount. Also advantageously the rear edge can be made of a flexible material, such as rubber, which brings about a rear edge that will, to a certain extent, yield during the cyclical loads. One essential advantage of this is a considerably reduction in noise and reduction of the forces in the blade structure. Nor will a flexible rear edge be damaged quite so easily during transport and mounting, which is otherwise the case with blades having conventional, firm rear edges.

A further advantage of being readily able to manufacture the entire or parts of the rear edge of the blade in one piece is that the rear edge can quite simply be exchanged in case it is worn or otherwise damaged.

FIG. 4 shows yet an embodiment of the series of profiles 301 according to the invention for a blade for a wind turbine. Here, like in FIG. 3, the profiles 101 show the outline of a blade in different positions along its longitudinal axis and as seen from the root of the blade towards the blade tip. Here, too, the series of profiles is developed such that the profile rear edges 105 are identical for all the profiles in the series. In this embodiment, the profile rear edges 105 are rotated or turned from one profile to another corresponding to the rear edge on the finished blade being twisted slightly along the expanse of the blade.

Likewise, the series of profiles can be developed and designed with a view to optimal aerodynamic properties for several different alternative profile rear edges. This is illustrated in FIG. 5, where it is shown how a profile is designed for two different profile rear edges, which two are repeated and are identical for a number of the profiles in the series of profiles of a blade. Hereby it is accomplished that it is possible to combine the same basic blade with rear edges having different configurations and thus to adapt the blade to the specific use of precisely that blade. For instance, the geographical area or the local wind conditions in which a wind turbine is to be deployed may mean that there are particular claims to noise emitted by the rotating blades. This can be solved eg by manufacturing the blade with the wider rear edge 501, whereby the wider blade is able to turn more slowly with ensuing less noise. Conversely, in another scenario, it may be advantageous with a sharp and shorter profile rear edge 502. Two different scenarios the blade design takes into consideration by the way in which the series of profiles of the blade was developed. The same blade moulds may thus be used to make blades that, as final products, end up having widely differing properties via the use of different rear edges. This entails a considerable reduction in the production costs associated with the blades, blade moulds being reusable to a wider extent.

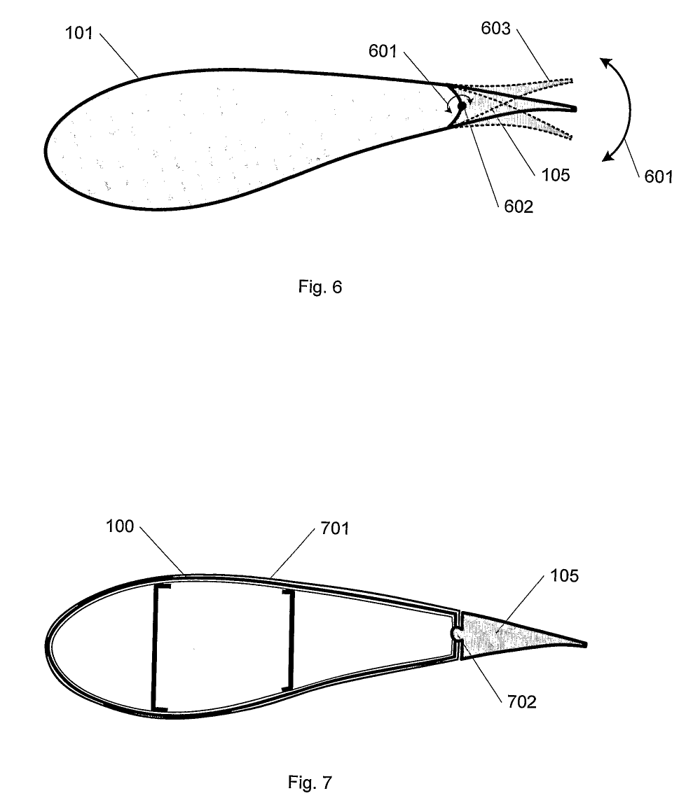

According to a further embodiment of the invention, the series of profiles designed on the basis of an identical rear edge is used to regulate the blade rear edge. In FIG. 6, a profile 101 from a series of profiles is shown, wherein the profile rear edge 105 is repeated in a number of profiles. Here, the rear edge 105 can be moved as illustrated by the arrows 601 and regulated and controlled as a function of the speed of the wind, the number of revolutions of the blade or the like. In this embodiment, the rear edge 105 is mounted in a joint 602 and can thereby be turned upwards and downwards as indicated by the dotted outlines 603 of the rear edge and serve as active flap. Likewise, the rear edge may conceivably be mounted and controlled in many other ways than by the rotary joint outlined herein. Such active flaps are much simpler and much more inexpensive to make in that the profile rear edge is kept constant in the series of profiles throughout the entire or major pats of the expanse of the blade.

FIG. 7 shows a cross-section of a blade 100 according to one embodiment of the invention. The load-carrying structure of the blade is here constituted of the blade shells 701 which do not comprise the rear edge 105 of the blade. This is easily done when the configuration of the rear edge is the same throughout the entire or major parts of the expanse of the blade. No matter whether the rear edge 105 is made of the same material as the remainder of the blade or of another, the outlined design of the blade 100 means that the rear edge is not exposed to the same forces and fatigue loads as the remainder of the blade, and therefore the wear on the rear edge is reduced considerably. FIG. 7 outlines an assembly method between rear edge 105 and the blade shells 701, where the rear edge is mounted with a tongue/groove connection 702 or the like. Likewise, the rear edge may conceivably be glued or welded onto the blade shells or optionally partially mounted by means of screws, bolts or the like depending on the materials selected and position on the blade. As mentioned above, the rear edge may also conceivably be moulded integrally with a blade shell.

It will be understood that the invention as taught in the present description and figures can be modified or changed while continuing to be comprised by the protective scope of the following claims.

1. A series of profiles for at least a portion of a blade comprising several profiles describing the outline of the blade transversally to its longitudinal axis, characterised in that at least some of the profiles in the series of profiles comprise approximately the same profile rear edge describing at least a portion of the rear edge of the blade.

2. A series of profiles for a blade according to claim 1, characterised in that at least some of the profiles of the series of profiles are determined on the basis of the rear edge of the profile.

3. A series of profiles for a blade according to one or more of claims 1-2, characterised in that the profile rear edge is repeated rotated from one profile to another.

4. A series of profiles for a blade according to one or more of claims 1-3, characterised in that the profile rear edge is repeated displaced from one profile to another.

5. A series of profiles for a blade according to one or more of claims 1-4, characterised in that at least some of the profiles of the series of profiles are determined on the basis of a number of different alternative profile rear edges.

6. A series of profiles for a blade according to one or more of claims 1-5, characterised in that the width of the profile rear edge constitutes approximately 2-10% of the width of the profile.

7. A blade, characterised in being described at least partially by a series of profiles as featured by claims 1-6.

8. A blade according to claim 7, characterised in that at least a portion of the rear edge of the blade is made in one piece.

9. A blade according to one or more of claims 7-8, characterised in that at least a portion of the rear edge of the blade is made of another material than the remainder of the surface of the blade.

10. A blade according to one or more of claims 7-9, characterised in that at least a portion of the rear edge of the blade is made of a flexible material, such as eg rubber.

11. A blade according to one or more of claims 7-10, characterised in that at least a portion of the rear edge of the blade is exchangeable.

12. A blade according to one or more of claims 7-11, characterised in that at least a portion of the rear edge of the blade constitutes a movable flap.

13. A blade according to one or more of claims 7-12, characterised in that at least a portion of the rear edge of the blade comprises a lightning conducting device.

14. A wind turbine comprising at least one blade described by claims 7-13.

15. Use of a series of profiles for the manufacture of a blade, which series of profiles is described by claims 1-6.

16. A method of designing a series of profiles for at least a portion of a blade comprising several profiles describing the outline of the blade transversally of its longitudinal axis, comprising to determine the shape of a profile rear edge describing at least a portion of the rear edge of the blade, said profile rear edge is repeated at least in some of the profiles in the series of profiles and, based on this, to determine the rest of the profiles in the series of profiles.
